(19) United States
(12) Patent Application Publication
(10) Pub. No.: US 2024/0252977 A1
(43) Pub. Date: Aug. 1, 2024

(54) OPTIMIZED GAS DEHYDRATION REGENERATION SYSTEM

(71) Applicant: Saudi Arabian Oil Company, Dhahran (SA)

(72) Inventors: Mohamed Ahmed Soliman, Oakville (CA); Yohannes Hilawe, Ras Tanura (SA); Wasim Arshad, Ras Tanura (SA); Abdullah Ghanmi, Dhahran (SA)

(21) Appl. No.: 18/103,167

(22) Filed: Jan. 30, 2023

(51) Int. Cl. B01D 53/14; B01D 53/18; B01D 53/26

(52) U.S. Cl. CPC B01D 53/1425; B01D 53/1412; B01D 53/1493; B01D 53/18; B01D 53/263

(57) ABSTRACT

A method and a system for dehydrating a gas stream while recovering energy are provided. An exemplary method includes sending a lean glycol stream to a glycol contactor, contacting a wet gas with the lean glycol stream in the glycol contactor, forming a rich glycol stream. The rich glycol stream from the glycol contactor is passed through an energy recovery unit, forming a low-pressure stream. The low-pressure stream is fed to a glycol regeneration column. Power from the energy recovery unit is used to generate a vacuum in the glycol regeneration column.

### TECHNICAL FIELD

This disclosure relates to an adsorption system for removing water from gas streams.

### BACKGROUND

Water is often removed from natural gas streams using an adsorption solvent, such as triethylene glycol (TEG). Lean TEG stream is contacted with the natural gas stream in a glycol contactor. This removes entrained water vapor, as well as other materials from the natural gas, forming a rich TEG stream. The rich TEG stream is passed to a regeneration section to remove any suspended solids, liquid hydrocarbon, gases, and water reforming the lean TEG stream which is often higher than 99% purity. The regeneration section includes reboilers, coolers, pumps, flash knockout drums, filters, and distillation towers to meet the purity requirements

### SUMMARY

An embodiment described herein provides a method for dehydrating a gas stream. The method includes sending a lean glycol stream to a glycol contactor, contacting a wet gas with the lean glycol stream in the glycol contactor, forming a rich glycol stream. The rich glycol stream from the glycol contactor is passed through an energy recovery unit, forming a low-pressure stream. The low-pressure stream is fed to a glycol regeneration column. Power from the energy recovery unit is used to generate a vacuum in the glycol regeneration column.

Another embodiment provides a system for dehydrating a natural gas. The system includes a dehydration section that includes a glycol contactor. The glycol contactor includes a lean glycol stream fluidically coupled to an inlet of the glycol contactor, a feed gas stream fluidically coupled to an inlet of the glycol contactor, a rich glycol stream fluidically coupled to an outlet of the glycol contactor, and a dry gas stream fluidically coupled to an outlet of the glycol contactor. The system also includes a glycol regeneration section. The glycol regeneration section includes an energy recovery unit to recover potential energy from the rich glycol outlet stream, a glycol regeneration column to remove water from the rich glycol outlet stream, and a vacuum system that uses the potential energy from the energy recovery unit to pull a vacuum on the glycol regeneration column.

### BRIEF DESCRIPTION OF DRAWINGS

FIG. 1 is a simplified process flow diagram of a gas dehydration system.

FIG. 2 is a simplified process flow diagram of a gas dehydration system using a reverse pump.

FIG. 3 is a simplified process flow diagram of a gas dehydration system using a reverse pump and an overhead condenser.

FIG. 4 is a simplified process flow diagram of a gas dehydration system using a liquid eductor and an overhead condenser.

FIG. 5 is a simplified process flow diagram of a gas dehydration system using a reverse pump and an overhead condenser with a lowered operating pressure.

FIG. 6 is a simplified process flow diagram of a gas dehydration system using a liquid eductor and an overhead condenser with an advanced process control unit.

FIG. 7 is a process flow diagram of a method for operating a gas dehydration system.

### DETAILED DESCRIPTION

Embodiments described in examples herein provide a process and system for the dehydration of natural gas using a glycol absorbent and a regeneration process that meets a dry gas specification of 7 lb of moisture per 1.0 MMSCFD. The lean glycol has a moisture concentration of less than 1%. The objective of the new process is to utilize the potential energy in the rich glycol liquid stream from the contactor to generate vacuum, for example, of about 10 psia, inside the glycol regeneration section and consequently minimize energy requirements, capital cost and glycol degradation. This potential energy is normally wasted across the level control valves upstream of the glycol regeneration section. Operating the glycol regeneration under vacuum will enable operating the reboiler at much lower temperature than 405° F. to meet the glycol moisture content and consequently minimize degradation.

As used herein glycol refers to any number of solvents that may be used to absorb water in a countercurrent contacting process. These include triethylene glycol and diethylene glycol, among others. Further, it may be understood that any process using triethylene glycol (TEG) may be used with the other solvents. The temperatures and pressures listed in examples herein are for the use of TEG.

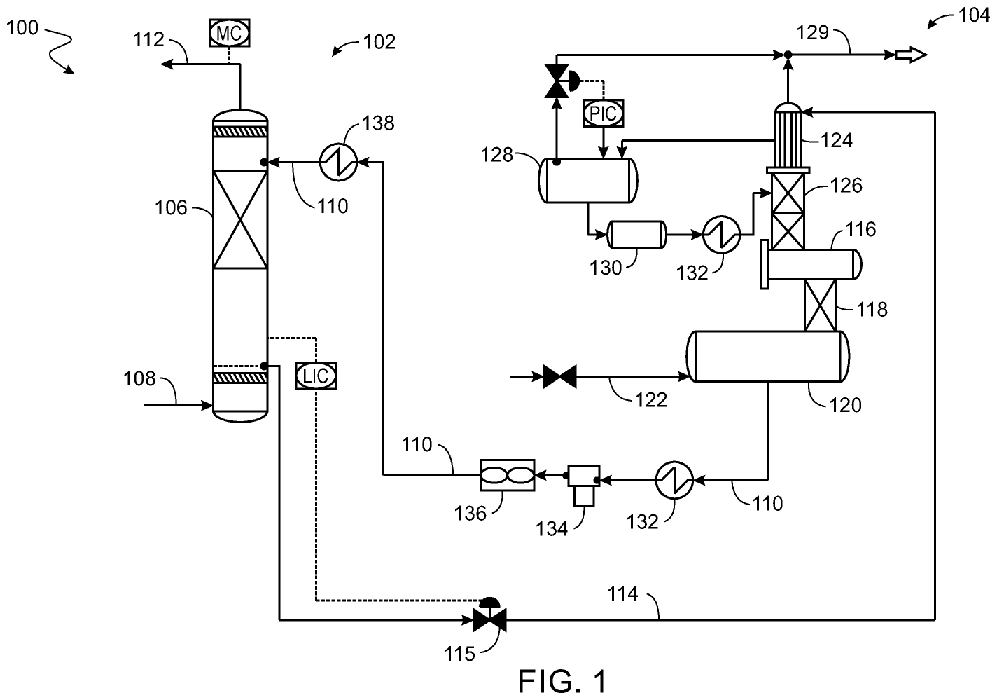

FIG. 1 is a simplified process flow diagram of a gas dehydration system 100. The gas dehydration system 100 includes two main plant sections, a gas dehydration section 102 and a glycol regeneration section 104. In the gas dehydration section 102, the wet gas is contacted with lean glycol to produce a dry gas meeting the standard specifications of 7 lb/MMSCFD. During the dehydration, a lean glycol is passed through the glycol regeneration section 104 to remove the water before returning to the gas dehydration section 102 as a rich glycol.

Before entering the glycol contactor 106, the feed gas stream 108 is scrubbed of any entrained liquids and solids in an inlet gas filter separator, for example, to prevent foaming in the contactor. The feed gas stream 108 enters the lower pre-separation section, containing a vane pack, where 90% of the entrained liquids are removed and drained into a sump area of the lower section, where they are removed under level control.

The liquid-free gas will enter the glycol contactor 106 near the bottom with a vane type inlet device for proper gas distribution and flow up through the glycol contactor 106. Subsequently gas dehydration is achieved by injecting lean glycol, such as triethylene glycol (TEG), into the glycol contactor 106, where absorption of the water present in the gas takes place due to intensive counter current contact between the gas and the glycol. The lean glycol stream 110 is fed to the top bed of the glycol contactor 106 and is evenly distributed by a liquid distributor. Structured packing in the glycol contactor 106 facilitates the mass transfer in the vessel. A demisting device at the top of the tower minimizes glycol carryover and limits the glycol loss through entrainment to less than 0.05 gallon/MMSCF. The pressure of the feed gas stream 108 to the gas dehydration is 410 psig. The feed temperature is 90° F. for the summer and winter cases. The dry gas stream 112 from the glycol contactor 106 flows to the HP compressor suction manifold at 400 psig and 95° F. with a water dew point of 8° F. (7 lbs per MMSCF water content). After passing through the glycol contactor 106, the glycol absorbs water and exits the glycol contactor 106 as a rich glycol stream 114.

The rich glycol stream 114 passes through the glycol regeneration section 104 to remove any suspended solids, liquid hydrocarbon, or gases from the glycol, and to remove the moisture/water from the glycol to reach glycol purity higher than 97%, e.g. reforming the lean glycol stream 110. The glycol regeneration section 104 contains reboilers, coolers, pumps, flash knockout drums, filters, and towers to meet the above requirements and achieve more than 97% glycol purity. A level control valve 115 controls the level of the liquids in the glycol contactor 106.

The reboiler 116 is the most important component of the regeneration system. The reboiler 116 is normally electric or indirect gas fired, for example, being heated by passing hot flue gases through a fully immersed fire tube within the reboiler 116. The bath temperature in the reboiler 116 is controlled at 400° F. by regulating the flow of fuel gas to the heater burners.

TABLE 1
Reboiler power demand for the glycol regeneration section.

| Dry Gas | Reboiler | Reboiler | TEG | TEG |
|---|---|---|---|---|
| Water Load | Temp. | Duty | Rate | Purity |
| 6 | 395 | 4.2 | 80 | 90 |
| lb/MMSCF | ° F. | MMBtu/hr | GPM | mole % |

The regenerated glycol flows over into a glycol-stripping column 118, which further increases lean glycol concentration to thereby allow product gas water dew point specification to be met. The glycol-stripping column 118 is designed to raise the lean glycol concentration up to 99.9 wt. %. From the glycol-stripping column 118, the regenerated glycol flows into a glycol accumulator 120. A stripping gas stream 122 is injected into the glycol accumulator 120. The lean glycol stream 110 is then recycled to the glycol contactor 106

The lean glycol stream 110 is further cooled in lean glycol cooler then routed to the suction of lean glycol circulation pumps and then recycled to the contactor to absorb water from gas.

The glycol contactor 106 is supplied with an integral knockout section in the base of the tower to remove entrained liquids. The gas stream leaves at the normal process temperature, where the majority of any liquid condensate is removed.

The glycol contactor 106 has an absorber section in which the wet saturated gas flowing from an inlet gas filter separator contacts the dehydrating glycol. The following features are provided for the absorber section to enhance efficiency. The absorber section includes a multi-chimney tray distributor designed to yield even gas distribution across the contactor cross sectional area is provided to yield optimum mass transfer performance from the structural packing. The structured packing each is a structured stainless steel packing that helps to ensure optimum gas/glycol contact surface for mass transfer. A drip pipe type glycol distributor system is provided to help ensure good liquid distribution on top of the packed bed at reduced flow-rates. The absorber section includes a mist eliminator that is located a sufficient distance above the inlet distributor to provide an appropriate disengagement space. The demister is a combination mist mat and vane pack and spans the full diameter of the vessel. It has a carryover specification of 0.1 US gallons/MMSCF.

The gas of the feed gas stream 108 is routed from the inlet gas scrubber through the inlet gas filter separator to remove particulate contamination to 99% of particles greater than 1 micron. The vessel contains a demister pad, and an array of filter elements to achieve coalescing and knockout of liquid droplets with filtration of any solid particles. A compartmented boot is provided to draw off liquid from upstream and downstream of the separation devices.

The glycol regeneration section 104 includes a glycol still condenser 124 that has a U-tube heat exchanger configuration. The glycol still condenser 124 utilizes the rich glycol stream 114 from the glycol contactor 106 as a condensing medium to obtain a reflux of between 20% and 25%. A glycol still column 126 has an overhead temperature that is controlled at 199° F., which modulates a bypass control valve to divert glycol around the glycol still column 126. Vapor from the overhead condenser Still Column OVHD Condenser Temperature is normally controlled at 190° F. to 210° F.

Fluids from the glycol still condenser 124 is passed to a glycol flash drum 128. The glycol flash drum 128 is designed as a three-phase horizontal separator providing a 30-minute residence time. The pressure in the glycol flash drum 128 is controlled at 50 to 65 psig by a split range pressure controller, which modulates control valves. The flash gas 129 is preferentially routed to the flare, the section of an atmospheric compressor, or to a fuel gas system via a fuel gas KO drum. Small quantities of liquid hydrocarbons will build up in the glycol flash drum 128. A combination of a glycol level control weir and a condensate collection bucket is provided to remove the hydrocarbon layer, which floats above the glycol phase.

The outlet of the glycol flash drum 128 flows through filters 130. For example, two 100% full-flow, cartridge type filters are provided downstream of the glycol flash drum 128. Each filter is designed to remove 99% of particles 5 microns and larger. Each filter is provided with isolation, drain, depressuring, and purge valves to allow for on-line media change.

In some embodiments, the filters 130 include a glycol purifier. The glycol purifier is a 10% slipstream activated carbon filter that removes residual hydrocarbons and degradation products. It is provided with isolation, depressuring, drain, and purge valves to facilitate maintenance. A glycol charcoal after filter is provided to remove any charcoal fines carried forward from the glycol purifier. The glycol charcoal after filter is a 10% slipstream type cartridge.

After the filters 130, the glycol from the glycol flash drum 128 passes through a lean/rich glycol heat exchanger 132. In some embodiments, the lean/rich glycol heat exchanger 132 is a Brown Fintube hairpin heat exchanger that heats the rich glycol to 320° F. before it enters the glycol still column 126. The rich glycol passes through the tube-side and the hot lean glycol flows through the shell side under gravity direct from the glycol accumulator 120 to reduce pressure drop and thus optimize net positive suction head (NPSH).

The glycol still column 126 contains two beds of stainless steel structured packing. The rich glycol enters the glycol still column 126 via a trough type distributor between the packed beds. Vapors from the glycol still column 126 are condensed in the glycol still condenser 124, which provides reflux, improving distillation efficiency and advising glycol losses.

The reboiler 116 contains a U-tube heat exchanger, which delivers a nominal design duty of 14.8 MMBTU/hr. In an embodiment, the heating medium is hot oil, which is provided by a closed circuit hot oil system, utilizing a direct-fired heater. The temperature of the reboiler 116 is controlled at 400° F., for example by modulating the flow of hot oil using a control valve. The temperature controller also has high and low alarms.

The liquid level in the reboiler 116 is controlled by a standpipe in the reboiler 116, which rises from the glycol-stripping column 118. Liquid overflows from the reboiler 116 into the glycol-stripping column 118 and the glycol accumulator 120 via the standpipe, which maintains a constant liquid level over the hot-oil tubing bundle. The height of the standpipe is set to ensure sufficient vapor/liquid disengagement space in the reboiler 116 prior to exiting the vessel through the glycol-stripping column 118. The glycol leaving the reboiler 116 is partially regenerated to 99 wt. % by distillation.

The glycol-stripping column 118 further concentrates the glycol using the stripping gas stream 122, for example, flowing up from the glycol accumulator 120. The stripping gas stream 122 may be dry gas from the glycol contactor 106. The dry gas is preheated in the glycol accumulator 120 and then passed to the bottom of the glycol-stripping column 118. Glycol flows down the glycol-stripping column 118, and contacts the stripping gas stream 122 in a bed of random packing. The stripping action achieves the target glycol concentration of 99.9 wt. %.

The glycol accumulator 120 provides the glycol circulation system with a surge volume, enabling a steady flow of glycol from the glycol accumulator 120 to be maintained, while ensuring an adequate period accumulate fresh glycol. The drum contains a heating coil, which is used to pre-heat the stripping gas stream 122 to the glycol-stripping column 118. The interconnected process unit that includes the glycol still condenser 124, the glycol still column 126, the reboiler 116, the glycol-stripping column 118, and the glycol accumulator 120 is termed the glycol regeneration column.

The lean glycol stream 110 from the glycol accumulator 120 passes through the shell-side of the lean/rich glycol heat exchanger 132 where it is cooled before feeding a lean glycol pump 134. The lean glycol pump 134 has inlet and outlet pulsation dampeners to reduce pipework vibration, and discharge relief valves to protect the downstream pipework against over-pressure. In some embodiments, multiple glycol pumps are used.

The lean glycol stream 110 is further cooled using a water or air-cooled heat exchangers 136 and 138. The temperature of the lean glycol is controlled at 5° F. above the overhead temperature of the glycol contactor 106.

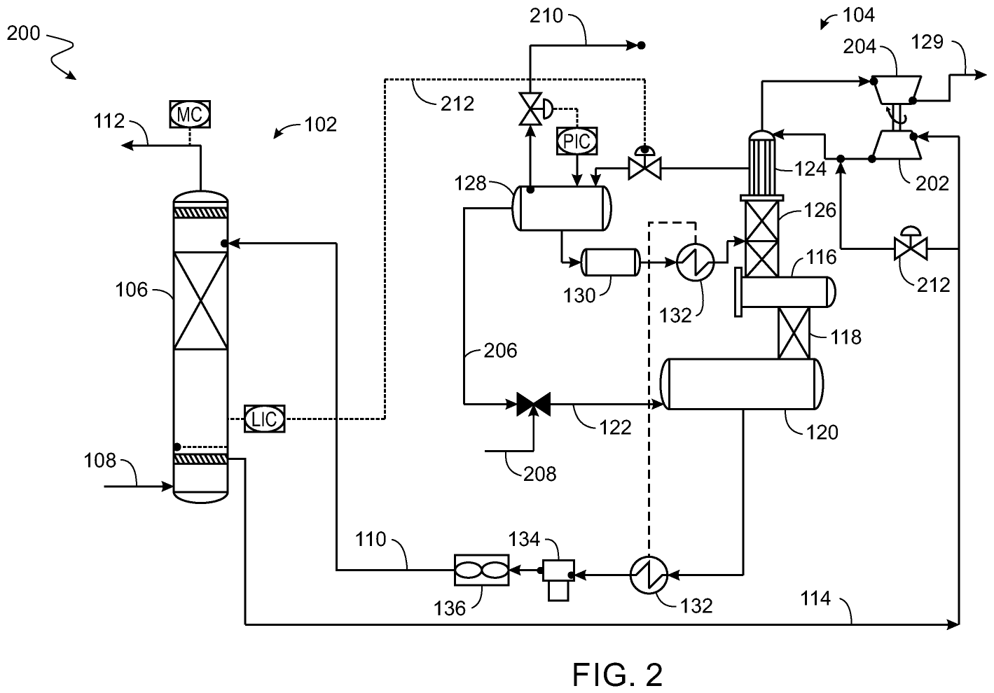

FIG. 2 is a simplified process flow diagram of a gas dehydration system 200 using a reverse pump, or hydraulic power recovery turbine (HPRT) 202, coupled to a vacuum system 204. In various embodiments, as described herein, the vacuum system is a blower, a ring compressor, or a liquid eductor. Like numbered items are as described with respect to FIG. 1. As described with respect to FIG. 1, the gas dehydration system 200 of FIG. 2 includes two main plant sections, a gas dehydration section 102 and a glycol regeneration section 104. In the gas dehydration section 102, the feed gas stream 108 is contacted with a lean glycol stream 110 to produce a dry gas stream 112 meeting the standard specifications of 7 lb/MMSCFD. A rich glycol stream 114 from the gas dehydration section 102 then passes through the glycol regeneration section 104 to remove the water before being recycled back to the gas dehydration section 102 as the lean glycol stream 110.

In the system of FIG. 2, the glycol regeneration section 104 is operated at vacuum conditions, for example, −3.0 psig, which results in lowering the duty cycle and temperature of the reboiler 116 and decreases the amount of stripping gas stream 122. Further, the quality of the glycol (TEG) and the gas dehydration are both improved, as shown in Table 3. Further, operating at a lower temperature will reduce the glycol degradation and the loss of glycol through vaporization.

In the gas dehydration system 200, the potential energy in the rich glycol stream 114 from the contactor, which is normally wasted across the level control valve 115 (FIG. 1) upstream of the TEG flash drum, is used to generate vacuum (less than 0 psig) inside the glycol regeneration section 104 using the HPRT 202, or power recovery pump, coupled with a vacuum pump or vacuum system 204. Operating the glycol regeneration section 104 at vacuum lowers energy requirements, capital cost, and glycol degradation. For example, operating the glycol regeneration section 104 under vacuum will enable operating the reboiler 116 at a lower temperature than 405° F. currently used to meet the glycol moisture content and consequently lowering degradation.

Further, the flash gas 206 from the glycol flash drum 128 is partially recovered for use as the stripping gas stream 122. This can lower the use of additional stripping gas 208. Pressure control of the glycol flash drum 128 is achieved by releasing an additional portion 210 of the gas from the glycol flash drum 128 to the downstream systems.

Generally, pumps are a means of fluid transport that convert mechanical energy into hydraulic energy to increase fluid pressure and flow. When process conditions call for pressure to be dissipated, a pump running in reverse may be applied as a reaction turbine to capture energy that would otherwise be wasted, for example, during throttling in a valve, or in dissipation to heat. The HPRT 202 may be used to drive a pump, generator, compressor, or other rotating machinery, such as the vacuum system 204 in the gas dehydration system 200 of FIG. 2.

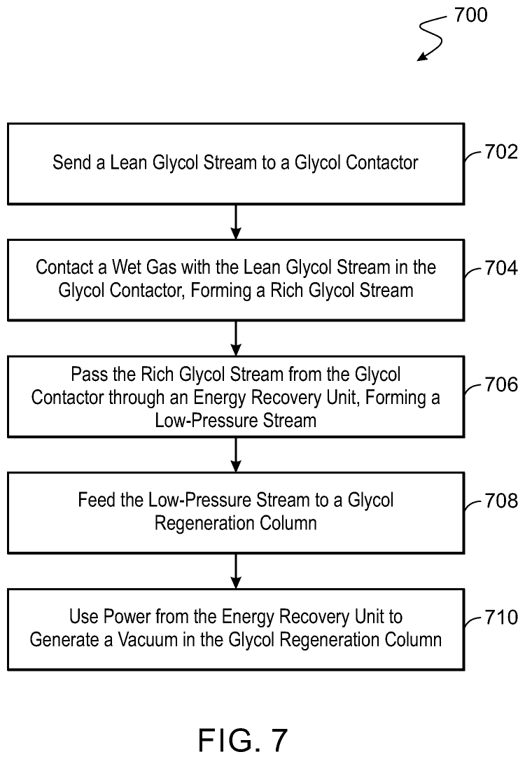

Speed of the HPRT 202 can be governed by an inlet control valve or a bypass valve 212, as shown for the gas dehydration system 200. Split range liquid level controllers are typically used to regulate turbines, for example as discussed further with respect to FIG. 7. The controller adjusts the inlet valve or further open the bypass valve 212 to allow flow around the HPRT 202 when the turbine is overpowered. Overspeed trip devices are often used with hydraulic turbines. This device may shuts the inlet valve and or fully opens the bypass valve 212, activating overspeed alarms and braking as required. Accordingly, the basic hydraulic behavior of centrifugal pumps operated as hydraulic power recovery turbines is similar to a pump, following the same sort of affinity laws over narrow ranges. In most instances, no design changes or modifications are needed for a pump to operate as a turbine.

The efficiency curve of the HPRT 202 generally follows the same behavior of a centrifugal pump, with a maximum efficiency that is similar, or slightly higher than that of the equipment being used as a pump. The HPRT 202 has a minimum flowrate requirement that is slightly higher than that of a centrifugal pump, below which the HPRT 202 begins to consume power, rather than generate it. The efficiency curve can also vary depending on its internal geometry. For instance, by having a variable geometry, with guide vanes adjusting their angle depending on the flowrate, the efficiency of the HPRT 202 can be improved over the entire capacity range when compared. Fluid properties affect the efficiency of the HPRT 202 in the same manner as in centrifugal pumps, with higher-viscosity fluids reducing the efficiency.

TABLE 2
Data used to design the HPRT 202.
Design Operating Conditions

| Pumping Temperature | 90° | F. |
|---|---|---|
| Flow | 81.3 | gpm |
| Discharge Pressure | 45 | psig |
| Suction Pressure | 400 | psig |
| Differential Pressure | 355 | psig |
| Differential Head | 701 | ft |
| TEG Specific Gravity | 1.12 | g/cc |
| TEG Viscosity | 13 cP at 90° | |
| | F. | |
| Atmospheric Pressure | 14.7 | psia |

The available hydraulic power that can be recovered in the HPRT 202, taking into account the fluid flowrates, properties and conditions is calculated using the following equation:

$$Where : \begin{matrix}{hp}_{hyd} = {Q}_{gpm} Δ {P}_{p s i} / 1715 \\ {hp}_{hyd} = 81.3 \times 355 / 1715 = 16.8 hp \\ {W}_{hyd} = 0.74 \; 757 \cdot {hp}_{hyd} \\ {W}_{hyd} = 12.6 kW \\ {w}_{{hyd}^{}} = HPRT hydraulic power , kW \\ {hp}_{hyd} = HPRT hydraulic power , hp \\ {Q}_{gpm} = Flow capacity , gal / min \\ SG = Fluid specific gravity , unitless \\ {DP}_{psi} = Differential head , ft\end{matrix}$$

Then, the hydraulic power is multiplied by an assumed HPRT efficiency of 80% to obtain the brake power:

$$Where : \begin{matrix}{W}_{b r a k e} = W hyd \cdot {η}_{HPRT} \\ {W}_{b r a k e} = 1 2.6 \times 0.8 = 10 kW \\ {W}_{brake} = HPRT brake power , kW \\ {η}_{HPRT} = HPRT efficiency , unitless\end{matrix}$$

Hence, 10 KW of break power is available to run the vacuum system 204.

In some embodiments, the vacuum system 204 that is powered by the HPRT 202 is a liquid ring compressor. A liquid-ring compressor is a positive-displacement, constant-volume, variable pressure compressor. These are available up to an inlet flow of 2,000 ACFM at pressure ranges from a low vacuum (4 in Hg. Absolute) to 100 psig. Liquid-ring compressors are most commonly used as vacuum pumps. Liquid-ring compressors are used in saturated gas applications, especially in vacuum towers, to produce the necessary vacuum.

Liquid-ring compressors consist of a round, multi-blade rotor that revolves in an elliptical casing. The elliptical casing is partially filled with a liquid, which is usually water, but it can be any process-compatible fluid. As the rotor turns, the blades form a series of chambers that contain gas with the liquid acting as a piston. The space between the blades serves as a rotor chamber. The gas inlet and discharge ports are located at the inner diameter of the rotor chamber. As the liquid leaves the rotor chamber, gas is drawn from the gas inlet into the rotor chamber through the gas inlet ports. As the rotor continues to rotate, the liquid returns to the rotor chamber and decreases the volume in the chamber. As the volume decreases, the gas pressure increases. As the rotor chamber passes the gas discharge port, the compressed gas is discharged through the gas outlet into a gas/liquid separator and then to the process. Commercially available liquid ring vacuum compressors can be applied to compress the vapors from vacuum condition (20 in Hg) till the atmospheric pressure (28.9 in Hg) while consuming up to 15 KW for a flow of 245 ACFM.

This configuration of liquid ring compressor can either be connected to Atmospheric pressure gas compressors' inlet or can be used as a booster for another train of liquid ring compressor to boost the pressure up to 50 psig.

TABLE 3
Comparison between current operations and new techniques

| | | FIG. 1 | FIG. 2 @ 0 | FIG. 2 @ 0.5 |
|---|---|---|---|---|
| | | (Current | SCF/gpm | SCF/gpm |
| | | operation) | stripping gas | stripping gas |
| Wet Gas Flow | MMSCFD | 350 | 350 | 350 |
| Wet Gas Inlet | ° F. | 90 | 90 | 90 |
| Temperature | | | | |
| Wet Gas Inlet | psig | 410 | 410 | 410 |
| Pressure | | | | |
| Lean TEG flow | gpm | 81.3 | 81.3 | 81.3 |
| Dry Gas Moisture | lb/MMSCF | 7 | 5.0 | 5.1 |
| Content | | | | |
| Lean TEG purity | wt. % | 99 | 99 | 99.05 |
| Regenerator Pressure | psig | 2.5 | −3 (11.7 psia) | −3 psg |
| | | | | (11.7 psia) |
| Reboiler Temp | ° F. | 395.5 | 380 | 370 |
| Reboiler Duty | MMBtu/hr | 4.2 | 3.9 | 3.6 |
| Striping Gas/TEG | SCF/gpm | 1 | 0 | 0.5 |
| Recirculated | | | | |
| Regenerator Off gas | pisg | 1 | 1.8 | 1.5 |
| discharge pressure | | | | |
| Flash drum operating | psig | 45 | 45 | 45 |
| press | | | | |
| TEG Loss with | Lb/hr | .063 | .055 | .05 |
| Vapors | | | | |
| Vapor flow to Blower | MMSCFD | 1.2 | 1.01 | 1.01 |

Operating the glycol regeneration section 104 in vacuum conditions provides a number of advantages over the current operations. The rich glycol stream 114 from the glycol contactor 106, which is at high-pressure, is used to power the new vacuum generation system. The ideal operating pressure of the glycol regeneration is 11.7 psia for TEG. Further, the recovery of dry gas from the glycol flash drum 128 for use as the stripping gas stream 122 lowers the use fuel gas improving the economy of the process. As discussed herein the lower operating temperature for the reboiler 116 will decrease the amount of glycol degradation as well as decreasing the duty cycle and energy consumption of the reboiler 116.

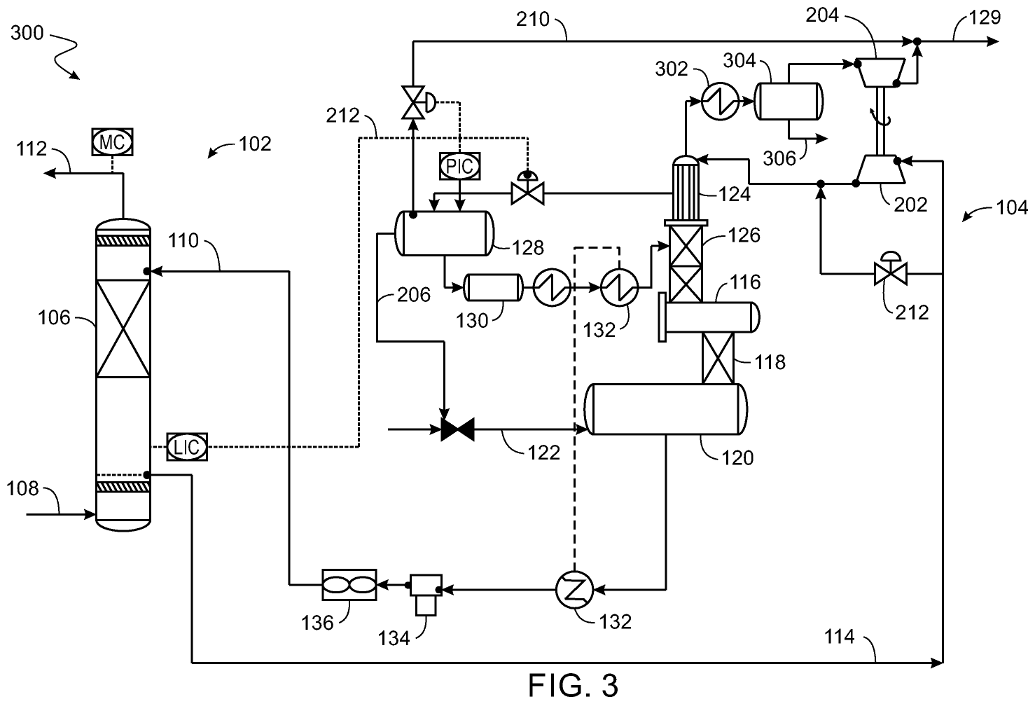

FIG. 3 is a simplified process flow diagram of a gas dehydration system 300 using a HPRT 202 and an overhead condenser. To improve the efficiency of the vacuum generation, some embodiments will include an off-gas condenser 302 and separation vessel 304 downstream of the glycol still condenser 124 to condense the water vapor and any hydrocarbons, which are removed as a waste stream 306 from the separation vessel 304. This will reduce the amount of off gas for the vacuum system 204, or liquid ring compressor, to handle and consequently increase the level of vacuum. The results of the additional process units 302 and 304 are shown in Table 4.

TABLE 4
comparison of current operations with the use
of the off-gas overhead condenser and separator

| | | FIG. 1 | | |
|---|---|---|---|---|
| | | (Current | FIG. 3 @ 0 | FIG. 3 @ 0.5 |
| | | operation) | stripping gas | stripping gas |
| Wet Gas Flow | MMSCFD | 350 | 350 | 350 |
| Wet Gas Inlet | ° F. | 90 | 90 | 90 |
| Temperature | | | | |
| Wet Gas Inlet | psig | 410 | 410 | 410 |
| Pressure | | | | |
| Lean TEG flow | gpm | 81.3 | 81.3 | 81.3 |
| Dry Gas Moisture | lb/MMSCF | 7 | 5.3 | 5.1 |
| Content | | | | |
| Lean TEG purity | wt. % | 99 | 99.01 | 99.05 |
| Regenerator Pressure | psig | 2.5 | −7.5 | −8.0 |
| | | | (7.0 psia) | (6.5 psia) |
| Reboiler Temp | ° F. | 395.5 | 340 | 330 |
| Reboiler Duty | MMBtu/hr | 4.2 | 2.6 | 2.2 |
| Striping Gas/TEG | SCF/gpm | 1 | 0 | 0.25 |
| Recirculated | | | | |
| Regenerator Off gas | pisg | 1 | 4.0 | 1.9 |
| discharge pressure | | | | |
| Flash drum operating | psig | 45 | 45 | 45 |
| press | | | | |
| TEG loss with | Lb/hr | .063 | 0.0385 | 0.0388 |
| Vapors | | | | |
| Vapor flow to Blower | MMSCFD | 1.2 | 0.39 | 0.42 |

Condensing the vapor in the off-gas condenser 302 substantially reduces the gas volume, for example, from about 1.2 MMSCFD to about 0.39 MMSCFD. Consequently, this results in a deeper vacuum pressure of −8.0 psig, which in turn lowers the operating temperature of the reboiler 116 to about 330° F. to about 340° F. This operating temperature is substantially lower than the operating temperature of the reboiler for the system described in FIG. 1, which is about 395° F.

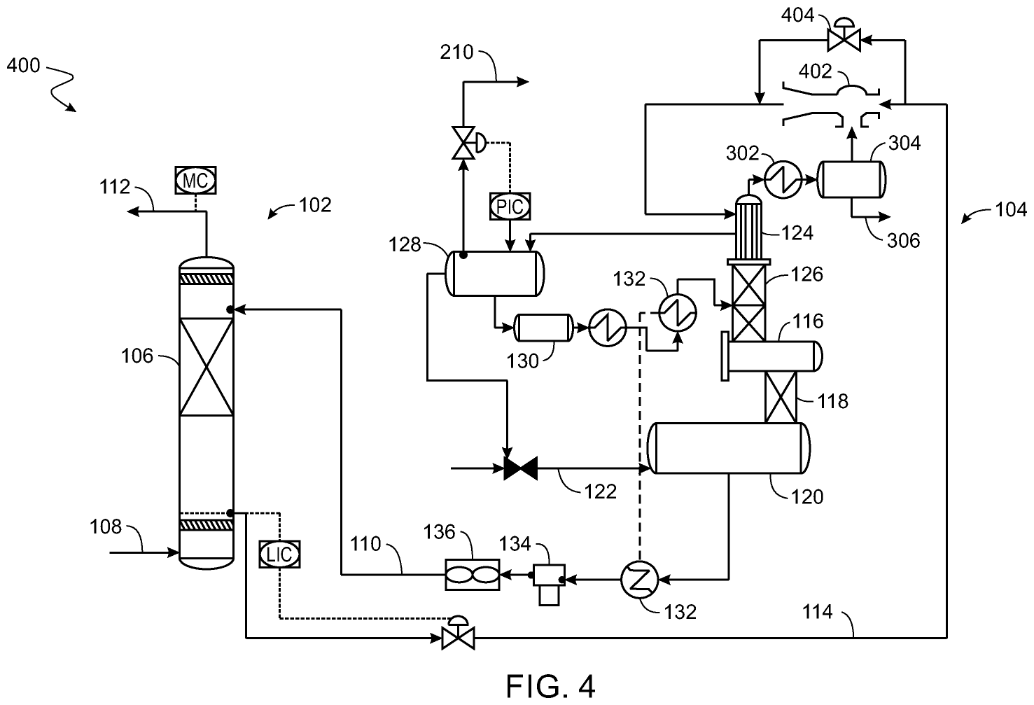

FIG. 4 is a simplified process flow diagram of a gas dehydration system 400 using a liquid eductor and an overhead condenser. Like numbered items are as described with respect to the previous figures. The energy recovery unit is not limited to an HPRT 202, but may be other devices that can be used to generate vacuum from the potential energy of the rich glycol stream 114.

In the gas dehydration system 400 of FIG. 4, a liquid eductor 402 is used to generate a vacuum from the high-pressure, rich glycol stream 114. The rich glycol stream 114 is fed into the inlet of the liquid eductor 402, and is allowed to drop in pressure in a Venturi tube, pulling a vacuum on a side feed, which is fluidically coupled to the separation vessel 304. The pressure is controlled by a bypass valve 404 that allows flow around the liquid eductor 402. The gas dehydration system 400 of FIG. 4 uses only static equipment, and thus, is simpler to operate. The glycol flash drum 128 is operated at near atmospheric conditions in order to generate deeper vacuum in the glycol regeneration section 104. The liquid eductor 402 is used with the off-gas condenser 302 and the separation vessel 304 to lower the amount of water returned to the glycol still condenser 124.

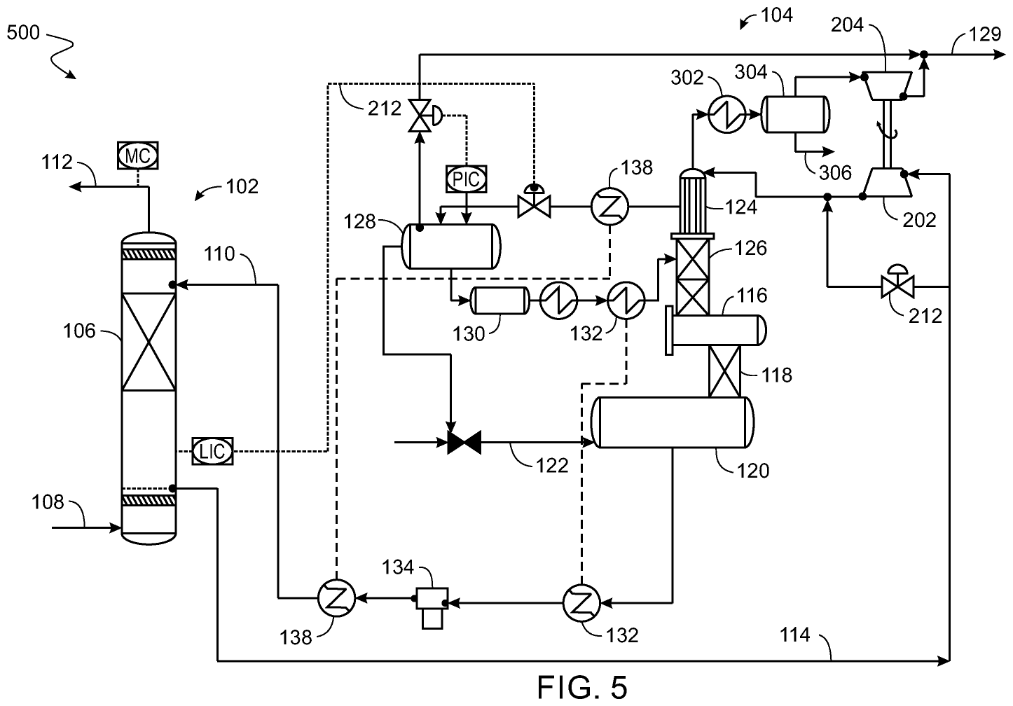

FIG. 5 is a simplified process flow diagram of a gas dehydration system 500 using a reverse pump and an overhead condenser with a lowered operating pressure. Like numbered items are as described with respect to previous figures. In this embodiment, the air-cooled heat exchanger 136 is replaced with a heat exchanger 138 coupled to the heat exchanger from the glycol still condenser 124. The fluid from the glycol still condenser 124 flows through one side of the heat exchanger 138 and the lean glycol stream 110 flows through the opposite side of the heat exchanger 138. Accordingly, the lean glycol stream 110 is used to heat the fluid from the glycol still condenser 124 prior to the glycol flash drum 128, while the lean glycol stream 110 is cooled prior to addition to the glycol contactor 106. In this embodiment, the operating pressure of the glycol flash drum 128 is lowered to about 45 psig. Instead of wasting energy in the air cooler, the heat from the lean glycol is used to preheat the rich glycol to the flash drum. This modification will help in degassing the rich glycol stream 114 and reduce the load in the reboiler 116 and the new proposed energy recovery system.

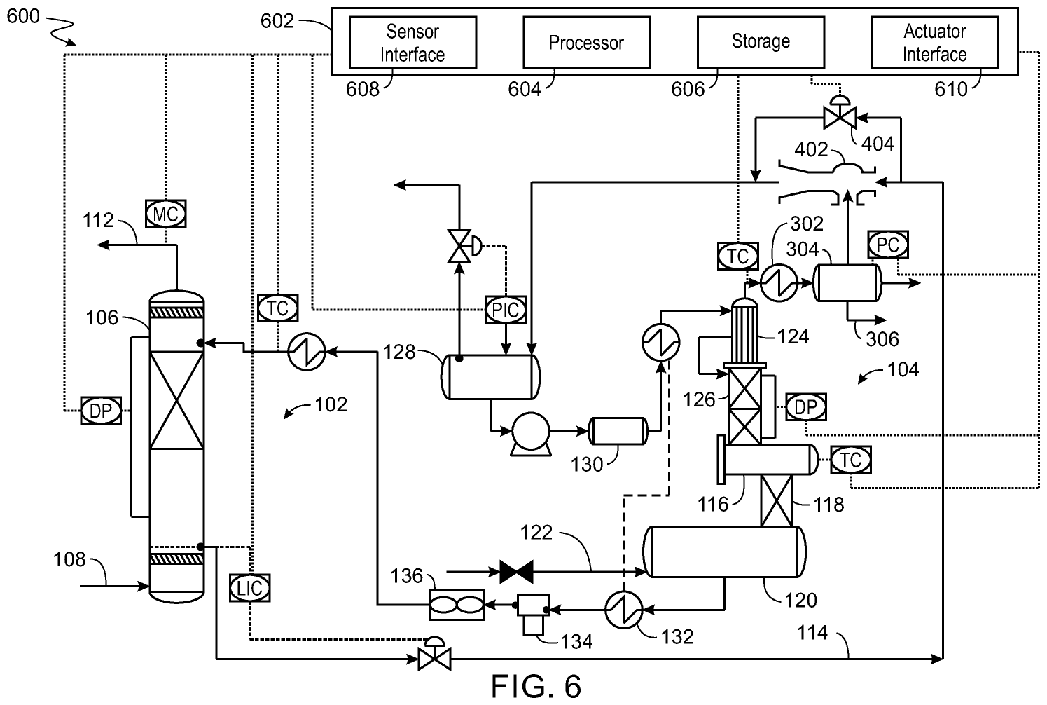

FIG. 6 is a simplified process flow diagram of a gas dehydration system 600 using a liquid eductor and an overhead condenser with an advanced process control unit (APC) 602. An APC 602 may be used with any of the configurations described in figures herein. The APC 602 includes a processor 604, such as a microcontroller, a programmable logic controller, a multithreaded processor, and the like. In various embodiments, the processor 604 may include processors from Intel®; Corporation of Santa Clara, California, from Advanced Micro Devices, Inc. (AMD) of Sunnyvale, California, or from ARM Holdings, LTD., Of Cambridge, England. Any number of other processors from other suppliers may also be used. The processor 604 communicates with other units over a bus, which may include any number of technologies, such as industry standard architecture (ISA), extended ISA (EISA), peripheral component interconnect (PCI), peripheral component interconnect extended (PCIx), PCI express (PCIe), or any number of other technologies. In some embodiments, the bus is a proprietary bus, for example, used in a system-on-a-chip based system.

The bus couples the processor to a storage unit 606 for the storage of data and programs used to operate the system. The storage unit 606 may include both short-term memory and long-term storage. The short-term memory may include any number of volatile and nonvolatile memory devices, such as volatile random-access memory (RAM), static random-access memory (SRAM), flash memory, and the like. In smaller devices, such as PLCs, the memory may include registers associated with the processor itself. The long-term storage is used for the persistent storage of information, such as data, applications, operating systems, and so forth. The long-term storage may be a nonvolatile RAM, a solid-state disk drive, or a flash drive, among others. In some embodiments, the long-term storage will include a hard disk drive, such as a micro hard disk drive, a regular hard disk drive, or an array of hard disk drives, for example, associated with a DCS or a cloud server.

The bus couples the processor to a sensor interface 608. The sensor interface 608 couples the APC 602 to the sensors used to monitor the dehydration process. In various embodiments, the sensor interface 608 includes a bank of analog-to-digital converters (ADCs), an I2C bus, a serial peripheral interface (SPI) bus, or a Fieldbus R), and the like. The bus also couples the processor to an actuator interface 610. In some embodiments, the actuator interface 610 includes a bank of digital-to-analog converters (DACs), a bank of relays, a bank of MOSFET power controllers, a serial peripheral interface (SPI), or a Fieldbus, and the like.

The sensor interface 608 and the actuator interface 610 couples the APC 602 to the units used to monitor and control the process. These include temperature controllers (TC), pressure controllers (PC and PIC), moisture controllers (MC), and level controllers (LIC). Other units controlled by the APC 602 include pumps, valves, flow controllers, and the like.

The storage unit 606 holds code to direct the processor 604 to control the gas dehydration system. In some embodiments, the storage unit 606 holds code that defines model predictive controllers, for example, trained using machine learning techniques, to monitor and control the overall performance while manipulating TEG flow, reboiler temperature, regenerator pressure, condenser operating temperature and different level controllers.

In some embodiments, the prediction models for the below process variables are built using mechanistic modeling, experimental design, or artificial intelligence analysis of the historical data, such as building a neural network. The use of the APC 602 may help to avoid problematic issues, such as glycol degradation. Further, in embodiments, the model will correlate the dry gas moisture content and lean glycol moisture content, for example, creating inferential or virtual sensors that will be used for the advanced process control of the gas dehydration section 102 and the glycol regeneration section 104.

The objective of the APC 602 is to minimize the operating cost of the gas dehydration. The model parameters for the output include the dry gas moisture content (in 1b/MMSCF) and the lean glycol moisture content (in mass %). The manipulated variables include the reboiler temperature, the interface levels in the separators, the glycol (TEG) flow rate, the pressure of the glycol regeneration section, and the operating temperature of the condenser. The constraints on the process include the temperature of the reboiler (less than about 400° F.), the differential pressure of the regenerator (less than about 0.1 psi), the differential pressure of the contactor tower (less than about 2 psi), and the differential pressure of the regenerator (less than about 400° F.). Further, the return temperature of the lean glycol to the contactor needs to be higher than wet gas inlet temperature by 15° F.

FIG. 7 is a process flow diagram of a method 700 for operating a gas dehydration system. The method 700 begins at block 702 when a lean glycol stream is sent to a glycol contactor for the dehydration of a gas stream. At block 704, a wet gas is contacted with the lean glycol stream in the glycol contactor, forming a rich glycol stream. At block 706, the rich glycol stream is passed from the glycol contactor through an energy recovery unit, forming a low-pressure stream. At block 708, the low-pressure stream is fed to a glycol regeneration column. At block 710, the power from the energy recovery unit is used to generate a vacuum in the glycol regeneration system.

The modifications of the glycol regeneration system discussed herein will decrease operating costs by energy savings, and achieve better results on dehydration. For example, the use of the flash gas as stripping gas, with fuel gas only used as a backup stripping gas, will decrease the amount of hydrocarbons used in the process. Further, the potential energy of the rich glycol that is wasted across the level control valve is recovered for use in the process, by generating a vacuum in the regeneration section. The decreased operating temperature of the reboiler will lower the degradation of the glycol (TEG).

### Embodiments

An embodiment described herein provides a method for dehydrating a gas stream. The method includes sending a lean glycol stream to a glycol contactor, contacting a wet gas with the lean glycol stream in the glycol contactor, forming a rich glycol stream. The rich glycol stream from the glycol contactor is passed through an energy recovery unit, forming a low-pressure stream. The low-pressure stream is fed to a glycol regeneration column. Power from the energy recovery unit is used to generate a vacuum in the glycol regeneration column.

In an aspect, the energy recovery unit is a hydraulic power recovery turbine (HPRT). In an aspect, the HPRT is used to power a blower to reduce the pressure in the glycol regeneration column. In an aspect, the HPRT is used to power a ring compressor to reduce the pressure in the glycol regeneration column. In an aspect, the method includes feeding the low-pressure stream from the HPRT to the glycol regeneration column. In an aspect, the HPRT is used to power a liquid ring compressor to reduce the pressure in the glycol regeneration column.

In an aspect, the method includes condensing water from an off-gas from the glycol regeneration column prior to generating the vacuum.

In an aspect, the energy recovery unit is a liquid eductor. In an aspect, the liquid eductor pulls a vacuum on a separator that separates water from an off-gas from the glycol regeneration column.

Another embodiment provides a system for dehydrating a natural gas. The system includes a dehydration section that includes a glycol contactor. The glycol contactor includes a lean glycol stream fluidically coupled to an inlet of the glycol contactor, a feed gas stream fluidically coupled to an inlet of the glycol contactor, a rich glycol stream fluidically coupled to an outlet of the glycol contactor, and a dry gas stream fluidically coupled to an outlet of the glycol contactor. The system also includes a glycol regeneration section. The glycol regeneration section includes an energy recovery unit to recover potential energy from the rich glycol outlet stream, a glycol regeneration column to remove water from the rich glycol outlet stream, and a vacuum system that uses the potential energy from the energy recovery unit to pull a vacuum on the glycol regeneration column.

In an aspect, the glycol regeneration section includes a glycol still condenser coupled to an off-gas condenser and a separation vessel.

In an aspect, the energy recovery unit includes a hydraulic power recovery turbine (HPRT) fluidically coupled between the rich glycol outlet stream and a glycol still condenser.

In an aspect, the energy recovery unit includes a liquid eductor fluidically coupled between the rich glycol outlet stream and a glycol flash drum, wherein a vacuum tap on the liquid eductor is fluidically coupled to the separation vessel.

In an aspect, the vacuum system includes a blower, wherein a low-pressure inlet of the blower is coupled to the glycol regeneration column. In an aspect, the vacuum system includes a blower, wherein a low-pressure inlet of the blower is coupled to the separation vessel. In an aspect, the vacuum system includes a ring compressor, wherein a low-pressure inlet of the ring compressor is coupled to the glycol regeneration column. In an aspect, the vacuum system includes a ring compressor, wherein a low-pressure inlet of the ring compressor is coupled to the separation vessel.

In an aspect, the system includes an advanced process control (APC) system. The APC includes a processor, a sensor interface, an actuator interface, and a storage unit. The storage unit includes code to direct the processor to use the sensor interface to obtain process values from temperature controllers, pressure controllers, moisture controllers, and level controllers, use the process values in a model to predict operating values for process parameters, and use the actuator interface to place the process values as settings in temperature controllers, pressure controllers, and level controllers.

In an aspect, the model is created using machine learning techniques. In an aspect, the machine learning techniques include artificial intelligence analysis of historical data. In an aspect, the model is created using mechanistic modeling, experimental design, or both.

Other implementations are also within the scope of the following claims.

What is claimed is:

1. A method for dehydrating a gas stream, comprising:
sending a lean glycol stream to a glycol contactor;
contacting a wet gas with the lean glycol stream in the glycol contactor, forming a rich glycol stream;
passing the rich glycol stream from the glycol contactor through an energy recovery unit, forming a low-pressure stream;
feeding the low-pressure stream to a glycol regeneration column; and
using power from the energy recovery unit to generate a vacuum in the glycol regeneration column.

2. The method of claim 1, wherein the energy recovery unit is a hydraulic power recovery turbine (HPRT).

3. The method of claim 2, wherein the HPRT is used to power a blower to reduce the pressure in the glycol regeneration column.

4. The method of claim 2, wherein the HPRT is used to power a ring compressor to reduce the pressure in the glycol regeneration column.

5. The method of claim 2, comprising feeding the low-pressure stream from the HPRT to the glycol regeneration column.

6. The method of claim 2, wherein the HPRT is used to power a liquid ring compressor to reduce the pressure in the glycol regeneration column.

7. The method of claim 1, comprising condensing water from an off-gas from the glycol regeneration column prior to generating the vacuum.

8. The method of claim 1, wherein the energy recovery unit is a liquid eductor.

9. The method of claim 8, wherein the liquid eductor pulls a vacuum on a separator that separates water from an off-gas from the glycol regeneration column.

10. A system for dehydrating a natural gas, comprising:
a dehydration section comprising a glycol contactor, comprising:
a lean glycol stream fluidically coupled to an inlet of the glycol contactor;
a feed gas stream fluidically coupled to an inlet of the glycol contactor;
a rich glycol stream fluidically coupled to an outlet of the glycol contactor; and
a dry gas stream fluidically coupled to an outlet of the glycol contactor;
a glycol regeneration section, comprising:
an energy recovery unit to recover potential energy from the rich glycol outlet stream;
a glycol regeneration column to remove water from the rich glycol outlet stream; and
a vacuum system that uses the potential energy from the energy recovery unit to pull a vacuum on the glycol regeneration column.

11. The system of claim 10, wherein the glycol regeneration section comprises a glycol still condenser coupled to an off-gas condenser and a separation vessel.

12. The system of claim 10, wherein the energy recovery unit comprises a hydraulic power recovery turbine (HPRT) fluidically coupled between the rich glycol outlet stream and a glycol still condenser.

13. The system of claim 11, wherein the energy recovery unit comprises a liquid eductor fluidically coupled between the rich glycol outlet stream and a glycol flash drum, wherein a vacuum tap on the liquid eductor is fluidically coupled to the separation vessel.

14. The system of claim 10, wherein the vacuum system comprises a blower, and wherein a low-pressure inlet of the blower is coupled to the glycol regeneration column.

15. The system of claim 11, wherein the vacuum system comprises a blower, and wherein a low-pressure inlet of the blower is coupled to the separation vessel.

16. The system of claim 10, wherein the vacuum system comprises a ring compressor, and wherein a low-pressure inlet of the ring compressor is coupled to the glycol regeneration column.

17. The system of claim 11, wherein the vacuum system comprises a ring compressor, and wherein a low-pressure inlet of the ring compressor is coupled to the separation vessel.

18. The system of claim 10, comprising an advanced process control (APC) system, comprising:
a processor;
a sensor interface;
an actuator interface; and
a storage unit, wherein the storage unit comprises code to direct the processor to:
use the sensor interface to obtain process values from temperature controllers, pressure controllers, moisture controllers, and level controllers;
use the process values in a model to predict operating values for process parameters; and
use the actuator interface to place the process values as settings in temperature controllers, pressure controllers, and level controllers.

19. The system of claim 18, wherein the model is created using machine learning techniques.

20. The system of claim 19, wherein the machine learning techniques include artificial intelligence analysis of historical data.

21. The system of claim 18, wherein the model is created using mechanistic modeling, experimental design, or both.
